(19) United States
(12) Patent Application Publication
(10) Pub. No.: US 2025/0256591 A1
(43) Pub. Date: Aug. 14, 2025

(54) ELECTRIFIED VEHICLE

(71) Applicant: TOYOTA JIDOSHA KABUSHIKI KAISHA, Toyota-shi (JP)

(72) Inventor: Takayuki SUGIMOTO, Inazawa-shi (JP)

(73) Assignee: TOYOTA JIDOSHA KABUSHIKI KAISHA, Toyota-shi (JP)

(21) Appl. No.: 18/953,093

(22) Filed: Nov. 20, 2024

(30) Foreign Application Priority Data
Feb. 9, 2024 (JP) 2024-018435

(51) Int. Cl. B60L 53/14; B60K 11/04

(52) U.S. Cl. CPC B60L 53/14; B60K 11/04

(57) ABSTRACT

Electrified vehicle includes a battery mounted on the electrified vehicle, a driving device having a traction motor disposed in a front storage space inside the hood in front of the electrified vehicle, a power control unit disposed in an upper portion of the driving device in the front storage space to drive the motor, and a charger disposed on the power control unit in the front storage space to charge the battery with electric power from an external power source. The charger includes a first substrate having an element being a generation source of electromagnetic waves, at least one second substrate having no element being a generation source of electromagnetic waves or having an element having a small influence as a source of electromagnetic waves, and a storage case for housing the first substrate and the second substrate, and the first substrate is disposed below the second substrate.

### CROSS-REFERENCE TO RELATED APPLICATION

This application claims priority to Japanese Patent Application No. 2024-018435 filed on Feb. 9, 2024, incorporated herein by reference in its entirety.

### BACKGROUND

### 1. Technical Field

The present disclosure relates to an electrified vehicle.

### 2. Description of Related Art

Conventionally, as an electrified vehicle of this type, an electrified vehicle has been proposed that includes a step-down converter connected to an auxiliary system power line and an auxiliary device connected to the auxiliary system power line via a filter (for example, refer to Japanese Unexamined Patent Application Publication No. 2010-207054 (JP 2010-207054 A)). The auxiliary power line is connected to an auxiliary battery. In the electrified vehicle, a noise current emitted from the step-down converter is suppressed from influencing the performance of the auxiliary device by connecting the auxiliary device connected via the filter.

### SUMMARY

However, in the electrified vehicle, the filter is provided in order to suppress the noise current of the step-down converter from influencing the performance of the auxiliary device. Therefore, since the number of components increases and the circuit becomes complicated, a contribution to a reduction in size and weight of the vehicle cannot be made.

The present disclosure provides an electrified vehicle that suppresses an influence of electromagnetic waves caused by an element disposed in a front space below a hood on the front of the electrified vehicle, the element being a generation source of electromagnetic waves.

An electrified vehicle of the present disclosure adopts the following techniques in order to achieve the objective.

The electrified vehicle of the present disclosure includes a battery mounted on the electrified vehicle, a driving device that includes a traction motor disposed in a front storage space inside a hood on the front of the electrified vehicle, a power control unit disposed on an upper portion of the driving device in the front storage space and configured to drive the traction motor, and a charger disposed above the power control unit in the front storage space and configured to charge the battery with power from an external power source. The charger includes a first substrate that includes an element being a generation source of electromagnetic waves, at least one second substrate that does not include an element being a generation source of electromagnetic waves or includes an element with a small influence as a generation source of electromagnetic waves, and a storage case that stores the first substrate and the second substrate. The first substrate is disposed below the second substrate.

The electrified vehicle of the present disclosure includes a battery mounted on the electrified vehicle, a driving device that includes a traction motor disposed in a front storage space inside a hood on the front of the electrified vehicle, a power control unit disposed on an upper portion of the driving device in the front storage space and configured to drive a motor, and a charger disposed above the power control unit in the front storage space and configured to charge the battery with power from an external power source. The charger includes a first substrate that includes an element being a generation source of electromagnetic waves, at least one second substrate that does not include an element being a generation source of electromagnetic waves or includes an element with a small influence as a generation source of electromagnetic waves, and a storage case that stores the first substrate and the second substrate. The first substrate is disposed below the second substrate. As a result, since the second substrate and a wall surface of the case are present above the element being a generation source of electromagnetic waves, the electromagnetic waves are shielded to some extent. As a result, the influence of electromagnetic waves due to the element being a generation source of electromagnetic waves can be suppressed. Here, the second substrate may be a substrate that includes only an element not being a generation source of electromagnetic waves, or a substrate that includes not only an element not being a generation source of electromagnetic waves but also an element with a small influence as a generation source of electromagnetic waves.

The electrified vehicle of the present disclosure may include a radiator disposed forward of the traction motor in a vehicle front-rear direction, and a cooling passage through which a cooling medium from the radiator flows may be disposed between the first substrate and the second substrate in the storage case. As a result, the cooling passage and the second substrate are sequentially stacked on the first substrate that includes an element being a generation source of electromagnetic waves, and a shielding effect of electromagnetic waves can be further enhanced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram schematically illustrating a configuration of a front part of an electrified vehicle according to an embodiment of the present disclosure; and

FIG. 2 is an explanatory diagram illustrating an exemplary state in which the boards of AC charger are housed in the storage case.

### DETAILED DESCRIPTION OF EMBODIMENTS

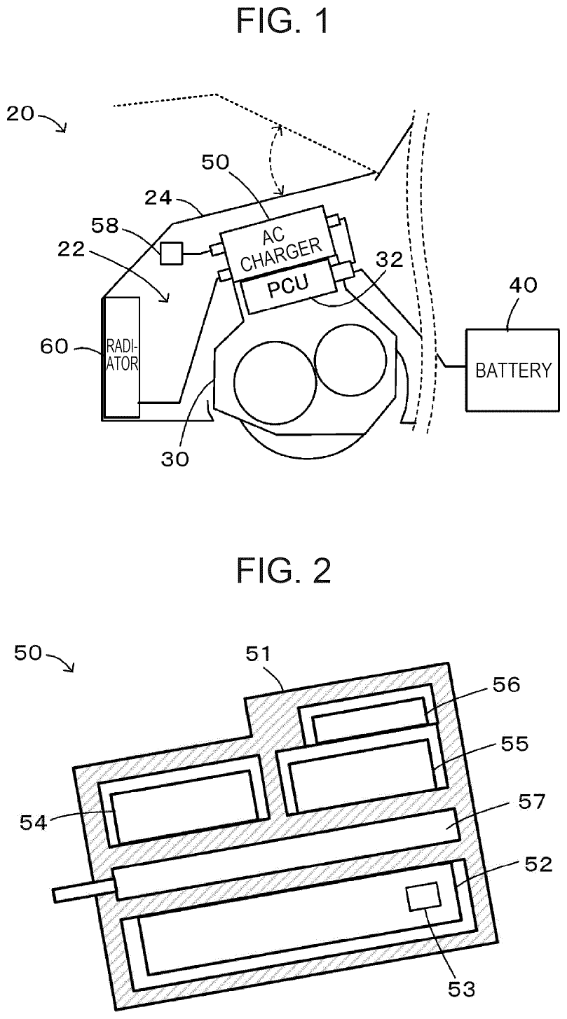

Next, a mode (embodiment) for carrying out the present disclosure will be described. FIG. 1 is a schematic configuration diagram schematically illustrating a configuration of a front part of an electrified vehicle 20 according to an embodiment of the present disclosure.

Electrified vehicle 20 of the embodiment comprises a driving device 30 in which a driving motor is incorporated in a lower front storage space (also sometimes referred to as a motor compartment) 22 of the hood 24. The hood 24 is located in the front portion of the vehicle and is openable and closable. A power control unit 32 that drives the motor of the driving device 30 is disposed in an upper portion of the driving device 30. The power control unit 32 includes a step-up converter or an inverter (not shown) and converts the DC power from a battery 40 disposed in the center or rear of the vehicle into three-phase AC power of a desired voltage to be applied to the motor.

In electrified vehicle 20 of the embodiment, AC charger 50 is disposed on the power control unit 32 of the front storage space 22. AC charger 50 is connected to an inlet 58 for connecting a connector from an external power source, and converts AC power from the external power source into DC power of a desired voltage to charge the battery 40.

FIG. 2 is an explanatory diagram illustrating an exemplary state in which the substrates 52, 54, 55, and 56 of AC charger 50 are housed in the storage case 51. The first substrate 52 is disposed at the lowermost layer of the storage case 51. The second substrate 54 and the third substrate 55 are disposed on the substrate 52 with the cooling passage 57 interposed therebetween. The fourth substrate 56 is disposed on the third substrate 55. The cooling passage 57 is supplied with the cooling medium cooled by the radiator 60 disposed at the foremost portion of the vehicle, and mainly cools the heating elements attached to the first substrate 52, the second substrate 54, and the third substrate 55.

The first substrate 52 is provided with element 53 being a generation source of electromagnetic waves such as PFC coils for improving the power factor. On the second substrate 54, the third substrate 55, and the fourth substrate 56, an element that does not have an element being a generation source of an electromagnetic wave or an element that has a small influence being a generation source of an electromagnetic wave is attached. Therefore, in electrified vehicle 20 of the embodiment, the first substrate 52 to which the element 53 being a generation source of the electromagnetic waves in AC charger 50 are attached is disposed in the lowermost layer of the storage case 51. The cooling passage 57, the second substrate 54, the third substrate 55, and the fourth substrate 56 are superposed on the first substrate 52. This enhances the shielding effect of the electromagnetic wave.

In electrified vehicle 20 of the above-described embodiment, the driving device 30 including the traction motor is disposed in the front storage space 22 inside the hood 24 in front of the vehicle. Further, a power control unit 32 for driving a motor is disposed on the driving device 30, and an AC charger 50 is further disposed on the power control unit 32. Then, in AC charger 50, the first substrate 52 having the element 53 being a generation source of the electromagnetic waves is disposed at the lowermost layer of the storage case 51. On the first substrate 52, a second substrate 54, a third substrate 55, and a fourth substrate 56 each having no element being a generation source of electromagnetic waves or an element having a small influence being a generation source of electromagnetic waves are arranged. As described above, the second substrate 54, the third substrate 55, and the fourth substrate 56 are present above the first substrate 52 having the element 53 being a generation source of the electromagnetic wave, and the wall surface of the storage case 51 is also present, so that the electromagnetic wave can be shielded to some extent. As a result, it is possible to suppress the influence of the electromagnetic wave by the element 53 being a generation source of electromagnetic wave.

In electrified vehicle 20 of the embodiment, a cooling passage 57 through which a cooling medium from the radiator 60 flows is disposed between the first substrate 52, the second substrate 54, and the third substrate 55 having the element 53 being a generation source of electromagnetic waves. Accordingly, the shielding effect of the electromagnetic wave can be further enhanced.

The correspondence between the main elements of the embodiments and the main elements of the disclosure described in the column of the means for solving the problem will be described. In the embodiment, the battery 40 corresponds to a “battery”. The hood 24 corresponds to a “hood”. The front storage space 22 corresponds to a “front storage space”. The driving device 30 corresponds to a “driving device”. The power control unit 32 corresponds to a “power control unit”. AC charger 50 corresponds to a “charger”. Electrified vehicle 20 corresponds to “electrified vehicle”. The element 53 corresponds to an “element being a generation source electromagnetic waves”. The first substrate 52 corresponds to a “first substrate”. The second substrate 54 and the third substrate 55 correspond to the “second substrate”. The storage case 51 corresponds to a “storage case”.

The correspondence between the main elements of the embodiment and the main elements of the disclosure described in the section of the means for solving the problem is an example for specifically explaining the embodiment of the disclosure described in the section of the means for solving the problem. Therefore, this does not limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Although the present disclosure has been described above using the embodiment, the present disclosure is not limited to the embodiment in any way, and may be implemented in various modes without departing from the scope of the present disclosure.

The present disclosure is applicable to a manufacturing industry of an electrified vehicle and the like.

What is claimed is:

1. An electrified vehicle comprising:
a battery mounted on the electrified vehicle;
a driving device that includes a traction motor disposed in a front storage space inside a hood on a front of the electrified vehicle;
a power control unit disposed on an upper portion of the driving device in the front storage space and configured to drive the traction motor; and
a charger disposed above the power control unit in the front storage space and configured to charge the battery with power from an external power source, wherein
the charger includes
a first substrate that includes an element being a generation source of electromagnetic waves,
at least one second substrate that does not include an element being a generation source of electromagnetic waves or includes an element with a small influence as a generation source of electromagnetic waves, and
a storage case that stores the first substrate and the second substrate, and
the first substrate is disposed below the second substrate.

2. The electrified vehicle according to claim 1, further comprising:
a radiator disposed forward of the traction motor in a vehicle front-rear direction; and
a cooling passage through which a cooling medium from the radiator flows is disposed between the first substrate and the second substrate in the storage case.
